(19) United States
(12) Patent Application Publication
(10) Pub. No.: US 2016/0066133 A1
(43) Pub. Date: Mar. 3, 2016

(54) LOCATION-BASED TELEPHONE CALLS OVER A WIRELESS LOCAL AREA NETWORK (WLAN)

(71) Applicant: Verizon Patent and Licensing Inc., Arlington, VA (US)

(72) Inventors: Mingxing S. Li, San Jose, CA (US); Ce Xu, San Ramon, CA (US); Priscilla Lau, Fremont, CA (US); Xuming Chen, San Ramon, CA (US)

(73) Assignee: VERIZON PATENT AND LICENSING INC., Arlington, VA (US)

(21) Appl. No.: 14/468,520

(22) Filed: Aug. 26, 2014

(51) Int. Cl. H04W 4/02; H04W 76/02; H04W 48/16

(52) U.S. Cl. CPC H04W 4/02; H04W 48/16; H04W 76/02

(57) ABSTRACT

A request to access a location-based service is received via a wireless access point (WAP). A WAP identifier associated with the WAP may be identified based on the request and a particular geographic location associated with the WAP may be determined based on the identifier. For example, a WAP information service (WIS) may store data associating geographic locations and WAP identifiers corresponding to a plurality of WAPs that include the WAP, and the particular geographic location may be determined by querying the WIS, based on the particular WAP identifier, to identify the particular geographic location. A communication may be established between the user device and location-based service based on the particular geographic location associated with the WAP.

### BACKGROUND

A wireless local area network (WLAN) may link a user device, such as a smart phone or a tablet, to a wireless access point (WAP), such as a wireless router, via wireless communications such as spread-spectrum or Orthogonal frequency-division multiplexing (OFDM) radio signals. For example, a WLAN may be based on various International Institute of Electrical and Electronics Engineers (IEEE) 802.11 standards, which are branded as Wi-Fi®. The WAP may be coupled to a service network, such as a wired, wireless or fiber optic, wide area network (WAN), to provide the user device with access to the Internet. WLANs have become popular because WAPs are relatively easy and inexpensive to install, and because WLANs enable multiple user devices to enter and move within local coverage areas to connect to the Internet.

A provider of “N11” (such as 711 for telecommunications relay services (TRS) and 911 for emergency call calls), short code dialing, “8yy” calls, 7 digit dialing, or other location-based services may use various techniques to determine a location of the user device communicating via a base station of a wireless data network, such as a long-term evolution (LTE) network. For example, the service provider may determine a location of a base station in the LTE network. Alternatively, if the user device supports global positioning system (GPS), the GPS location of the user device can be provided to the location-based service using various protocols, such as the open mobile alliance (OMA) secure user plane location (SUPL) protocol, the LTE location positioning protocol (LPP), etc.

### BRIEF DESCRIPTION OF THE DRAWINGS

FIG. 1 is a diagram of an exemplary network in which systems and/or methods described herein may be implemented;

FIG. 2 is a diagram of exemplary components of one or more devices of the network illustrated in FIG. 1;

FIG. 3 is a diagram of exemplary components of a user equipment of the network depicted in FIG. 1;

FIGS. 4A-4F are diagrams of exemplary operations capable of being performed by portions of the network illustrated in FIG. 1; and

FIG. 5 is a flow chart of an exemplary process for handling a request, received via a wireless access point, for a location-based service, according to an implementation described herein.

### DETAILED DESCRIPTION OF PREFERRED EMBODIMENTS

The following detailed description refers to the accompanying drawings. The same reference numbers in different drawings may identify the same or similar elements.

Systems and/or methods described herein may relate to receiving, from a user device, a request to access a location-based service via a wireless access point (WAP). A WAP identifier associated with the WAP may be identified based on the request and a particular geographic location associated with the WAP may be determined based on the identifier. For example, a WAP information service (WIS) may store data associating geographic locations and WAP identifiers corresponding to a plurality of WAPs that include the WAP, and the particular geographic location may be determined by querying the WIS, based on the particular WAP identifier, to identify the particular geographic location. A communication may be established between the user device and location-based service based on the particular geographic location associated with the WAP.

As used herein, the terms “caller” and/or “user” may be used interchangeably. Also, the terms “caller” and/or “user” are intended to be broadly interpreted to include a user device or a user of the user device.

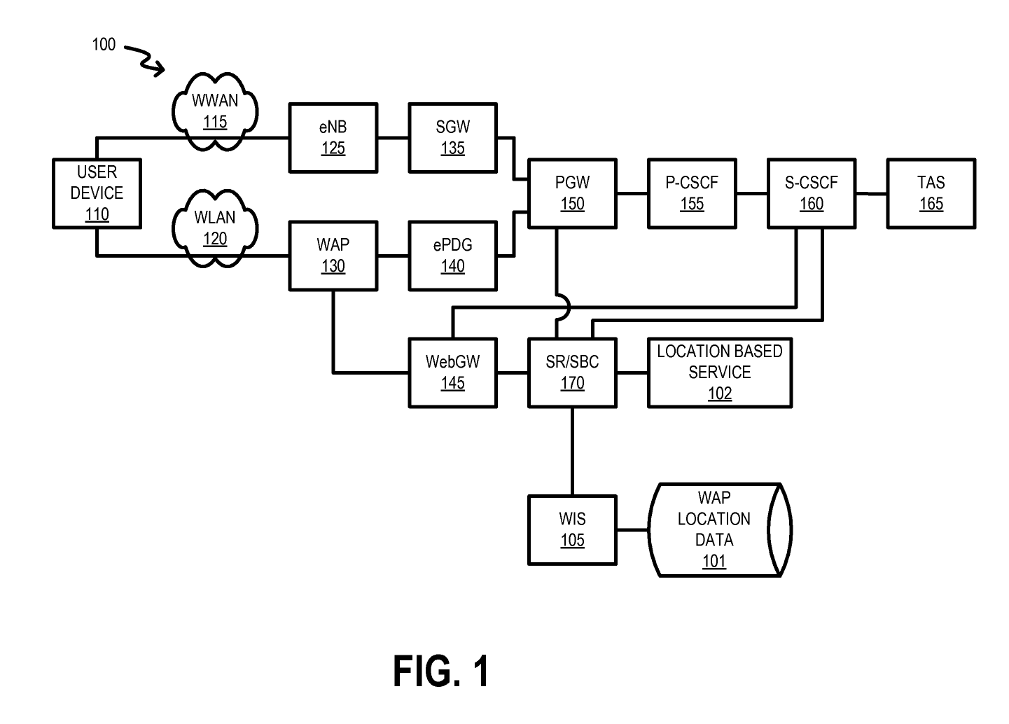

FIG. 1 is a diagram of an exemplary network 100 that may include a WAP information server (WIS) 105 to acquire and store WAP location data 101 that may be used to provide a location-based service 102 to a user device 110 communicating via a WAP 130, according to one implementation. As shown in FIG. 1, network 100 may include WIS 105, user device 110, a wireless wide area network (WWAN) 115, a wireless local area network (WLAN) 120), an enhanced e-Node B (eNB) 125, a serving gateway (SGW) 135, an evolved packet data gateway (ePDG) 140, an Internet (e.g., the “world-wide web”) gateway (webGW) 145, a packet data network (PDN) gateway (PGW) 150, a proxy call session control function (P-CSCF) 155, a serving CSCF (S-CSCF) 160, a telephony application servicer (TAS) 165, and a switch relay/session border control (SR/SBC) 170.

Components of network 100 may interconnect via wired and/or wireless connections or links. A single one of each of WIS 105, user device 110, WWAN 115, WLAN 120, eNB 125, SGW 135, ePDG 140, webGW 145, PGW 150, P-CSCF 155, S-CSCF 160, TAS 165, and SR/SBC 170 has been illustrated in FIG. 1 for simplicity. In practice, there may be a plurality of WISes 105, user devices 110, WWANs 115, WLANs 120, eNBs 125, SGWs 135, ePDGs 140, webGWs 145, PGWs 150, P-CSCFs 155, S-CSCFs 160, TASes 165, and/or SR/SBCs 170 in network 100. Also, in some instances, one or more of the components of network 100 may perform one or more functions described as being performed by another one or more of the components of network 100.

WIS 105 may collect and store WAP location data 101 identifying locations of WAPs 130. WAP location data 101 may include, for example, an IP address, a media access control (MAC) address, an electronic serial number (ESN), a mobile equipment identifier (MEID), an international mobile equipment identity (IMEI), or other device identifier associated with WAP 130. WAP location data 101 further include information identifying a geographic location associated with the WAP 130. For example, WAP location data 101 may include information identifying a street address, a city, a state, region, country, a longitude/latitude pair, etc. associated with WAP 130. For example, WIS 105 (or another device) may provide an interface (e.g., a web page) for registering WAP 130 with a service network (e.g., a network connecting WAP 130 to location-based service 102), and an operator of WAP 130 may identify an associated location via the interface during registration of WAP 130.

In addition or alternatively, WIS 105 may include, in WAP location data 101, data identifying an eNB 125 associated with the WAP 130 (e.g., a particular eNB 125 that is geographically closest to, and/or in engaged in wireless communications with, user device 110 and/or WAP 130—e.g., via WLAN 120). For example, WAP location data 101 may include an identifier associated with eNB 125 (e.g., a network address), a tracking area code (TAC) that identifies a tracking area within WWAN 115, an enhanced global cell identity (ECGI) identifies a cell associated with eNB 125, etc For example, WIS 105 may receive data from user device 110 identifying eNB 125 (e.g., the eNB 125 connected communicating with user device 110 via WWAN 115)/Atty.

When a request to access location-based service 102 is received from user device 110 via a particular WAP 130, one or more components of network 100 (e.g., SGW 135, ePDG 140, webGW 145, PGW 150, P-CSCF 155, S-CSCF 160, TAS 165, or SR/SBC 170) may identify the particular WAP 130 (e.g., based on a source network address or other information associated with the request), and may interface with WIS 105 to request a geographic location of the particular WAP 130. The geographic location may be used to identify an appropriate location-based service 102 (e.g., a particular location-based service 102 associated with the geographic location of the particular WAP 130), and the request may be forwarded via network 100 to the appropriated location-based service 102.

User device 110 may include a digital telephone (e.g., a device implementing voice over internet, or VoIP, technology), a cellular telephone, a smart phone, a PDA (e.g., that can include a radiotelephone, a pager, Internet/intranet access, etc.), a laptop computer (e.g., with a WLAN network card), or other types of mobile communication devices. In one implementation, user device 110 may include a mobile communication device that is capable of supporting location-based services, such as requesting emergency services, via WAP 130.

WWAN 115 may link user device 110 to eNB 125 using mobile telecommunication cellular network technologies from a wireless service provider, such as long-term evolution (LTE), worldwide interoperability for microwave access (WiMAX), universal mobile telecommunications system (UMTS), Code division multiple access 2000 (CDMA2000), global system for mobile communications (GSM), cellular digital packet data (CDPD) or mobitex, to transfer data. WWAN 115 may exchange voice and/or data between user device 110 and eNB 125. For example, a connection may be established via WWAN 115 to support VoIP communications between user device 110 and eNB 125.

WLAN 120 may link user device 110 to WAP 130 via short range wireless communications, such as spread-spectrum or Orthogonal frequency-division multiplexing (OFDM) radio signals. For example, WLAN 120 may be based on various International Institute of Electrical and Electronics Engineers (IEEE) 802.11 standards, which are branded as Wi-Fi®.

The eNB 125 may include one or more computation and/or communication devices that may receive voice and/or data from SGW 135 and may transmit that voice and/or data to user device 110 via an air interface, such as WWAN 115. The eNB 125 may also receive voice and/or data from user device 110 over the air interface (e.g., WWAN 115) and may transmit the voice and/or data to SGW 135 or another user device 110.

WAP 130 may include a wireless device, such as a wireless router, to receive voice and/or data from ePDG 140 and may transmit that voice and/or data to user device 110 via a short-range air interface (e.g., via WLAN 120). WAP 130 may also receive voice and/or data from user device 110 over WLAN 120 and may transmit the voice and/or data to ePDG 140 or another user device 110. WAP 130 may be coupled to a service network, such as a wired, wireless or fiber optic, wide area network (WAN), to provide the user device with access to the Internet.

In one implementation, WAP 130 may include a wireless broadband device, such as a broadband unit that includes a WLAN module capable of communicating with user device 110 via WLAN 120. The broadband unit may include a broadband home router (BHR) capable of communicating with a customer premises network. In another implementation, WAP 130 may include a broadband modem that behaves like a DSL modem except that WAP 130 connects via WLAN 120 to user device 110. For example, WAP 130 may connect to a router or switch that connects to various devices (e.g., computers) located at a customer premises.

SGW 135 may include a traffic transfer device (or network device), such as a gateway, a router, a switch, a firewall, a NIC, a hub, a bridge, a proxy server, an optical add drop multiplexor (OADM), or some other type of device that processes and/or transfers traffic. In one implementation, SGW 135 may control and manage one or more base stations (e.g., eNB 125), and may perform data processing to manage utilization of radio network services. SGW 135 may transmit/receive voice and data to/from eNB 125, other SGWs, and/or PGW 150. SGW 135 may provide a local anchor point for inter-base station handover, and may provide IP routing and forwarding functions.

The ePDG 140 may include one or more devices to enable secure data transmissions with a user device 110 via WAP 130. For example, ePDG 140 may act as a termination node of internet protocol security (IPsec) tunnels established with the user device 110 via WAP 130 (e.g., via WLAN 120). The ePDG 140 may manage sessions with user device 110 via WAP 130 to provide access to the Internet for certain types of user device 110, such as a smart phone or other device compatible with voice over internet protocol (VoIP) technology.

WebGW 145 may include one or more devices to manage sessions with user device 110 via WAP 130 to provide access to the Internet for certain types of user device 110 that are not compatible with ePDG 140. For example, WebGW 145 may manage internet access (e.g., by providing a connection to SR/SBC 170 for a personal computer, a laptop, a tablet, etc.

PGW 150 may include a traffic transfer device (or network device), such as a gateway, a router, a switch, a firewall, a network interface card (NIC), a hub, a bridge, a proxy server, an optical add-drop multiplexer (OADM), or some other type of device that processes and/or transfers traffic. In one implementation, PGW 150 may connect to a packet data network, and PGW 150 may perform policy enforcement, per-user based packet filtering (e.g., by deep packet inspection), charging support, lawful interception, user device IP address allocation, packet screening, etc. related to packet data network.

P-CSCF 155 may include one or more server devices, or other types of computation or communication devices, that gather, process, search, and/or provide information in a manner described herein. In one implementation, P-CSCF 155 may function as a proxy server for user device 110, where session initiation protocol (SIP) signaling traffic to and from user device 110 may go through P-CSCF 155. P-CSCF 155 may validate and then forward requests from user device 110, and may process and forward responses to user device 110.

S-CSCF 160 may include one or more server devices, or other types of computation or communication devices, that gather, process, search, and/or provide information in a manner described herein. In one implementation, S-CSCF 160 may be a central node of the signaling plane, and may perform session control. S-CSCF 160 may handle SIP registrations, may inspect signaling messages, may decide to which device(s) a SIP message may be forwarded, may provide routing services, etc. S-CSCF 160 may further invoke various application servers (e.g., WIS 105 and/or TAS 165) when performing routing functions.

TAS 165 may include one or more server devices that function as a back-to-back SIP user agent to maintain a call state for user device 110. TAS 165 may include, for example, a device to implement service logic that provides call processing services, such as digit analysis, routing, call setup, call waiting, call forwarding, conferencing, etc.

SR/SBC 170 may provide for signaling as well as a set up, maintenance, and/or tear down of media channels, such as VoIP sessions, video streams, instant messaging sessions, etc. SR/SBC 170 may also control call admission to location-based service 102. For example, SR/SBC 170 may monitor SIP transmission via a data network to enable VoIP sessions with an emergency messaging entity, such as a public safety answering point (PSAP). In another example, SR/SBC 170 may initiate communications over a circuit switched communications network, such as a public switched telephone network (PSTN) to support location-based service 102. SR/SBC 170 may also function as a firewall so that user device 110 and/or WAP 130 cannot determine how a call is routed to location-based service 102. For example, SR/SBC 170 may hide external and internal IP addresses associated with user device 110, WAP 130, and/or location-based service 102.

Although FIG. 1 shows exemplary components of network 100, in other implementations, network 100 may contain fewer components, different components, differently arranged components, or additional components than those depicted in FIG. 1.

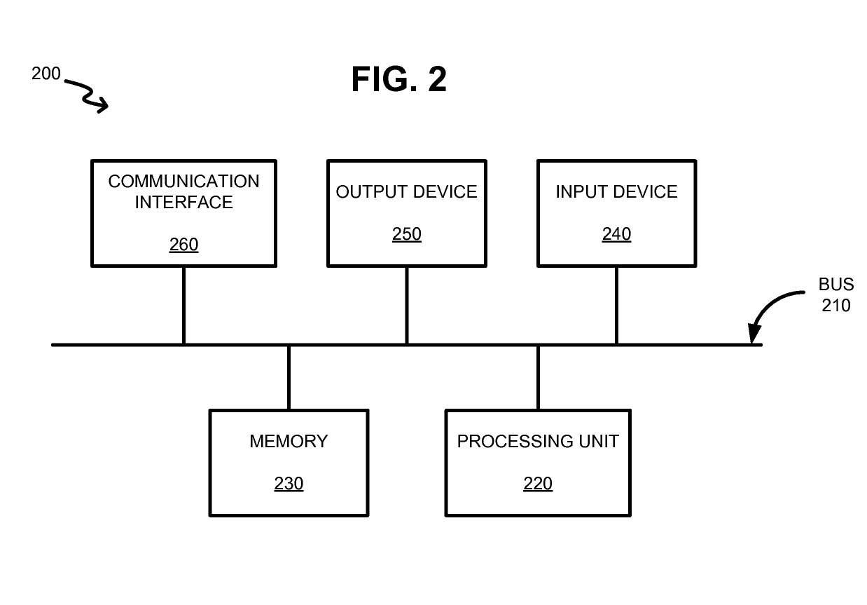

FIG. 2 is a diagram of exemplary components of a device 200 that may correspond to one or more devices of network 100. As illustrated, device 200 may include a bus 210, a processing unit 220, a main memory 230, a ROM 240, a storage device 250, an input device 260, an output device 270, and/or a communication interface 280. Bus 210 may include a path that permits communication among the components of device 200.

Processing unit 220 may include one or more processors, microprocessors, or other types of processing units that may interpret and execute instructions. Main memory 230 may include a RAM or another type of dynamic storage device that may store information and instructions for execution by processing unit 220. ROM 240 may include a ROM device or another type of static storage device that may store static information and/or instructions for use by processing unit 220. Storage device 250 may include a magnetic and/or optical recording medium and its corresponding drive.

Input device 260 may include a mechanism that permits an operator to input information to device 200, such as a keyboard, a mouse, a pen, a microphone, voice recognition and/or biometric mechanisms, etc. Output device 270 may include a mechanism that outputs information to the operator, including a display, a printer, a speaker, etc. Communication interface 280 may include any transceiver-like mechanism that enables device 200 to communicate with other devices and/or systems. For example, communication interface 280 may include mechanisms for communicating with another device or system via a network.

As described herein, device 200 may perform certain operations in response to processing unit 220 executing software instructions contained in a computer-readable medium, such as main memory 230. A computer-readable medium may be defined as a non-transitory memory device. A memory device may include space within a single physical memory device or spread across multiple physical memory devices. The software instructions may be read into main memory 230 from another computer-readable medium or from another device via communication interface 280. The software instructions contained in main memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may include fewer components, different components, differently arranged components, or additional components than those depicted in FIG. 2. Alternatively, or additionally, one or more components of device 200 may perform one or more other tasks described as being performed by one or more other components of device 200.

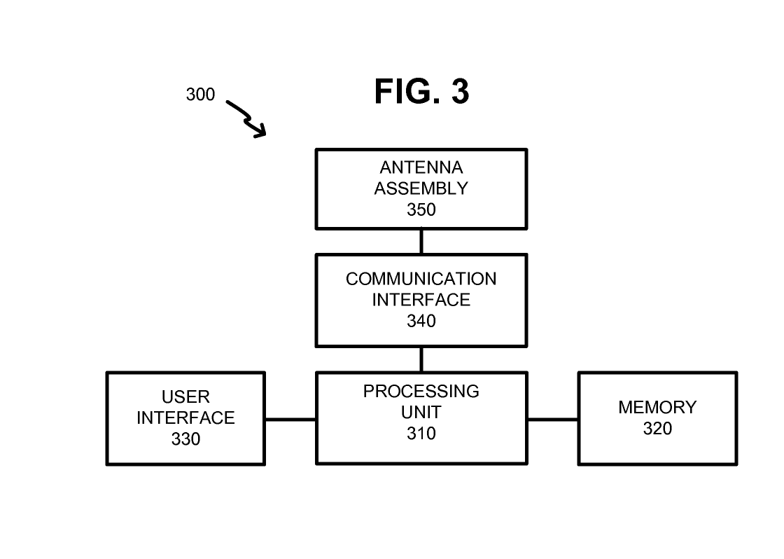

FIG. 3 depicts a diagram of exemplary components of a communications device 300 that may correspond to, for example, user device 110. As illustrated, communications device 300 may include a processing unit 310, memory 320, a user interface 330, a communication interface 340, and/or an antenna assembly 350.

Processing unit 310 may include one or more processors, microprocessors, ASICs, FPGAs, or the like. Processing unit 310 may control operation of communications device 300 and its components. In one implementation, processing unit 310 may control operation of components of communications device 300 in a manner described herein.

Memory 320 may include a RAM, a ROM, and/or another type of memory to store data and instructions that may be used by processing unit 310.

User interface 330 may include mechanisms for inputting information to communications device 300 and/or for outputting information from communications device 300. Examples of input and output mechanisms might include buttons (e.g., control buttons, keys of a keypad, a joystick, etc.) or a touch screen interface to permit data and control commands to be input into communications device 300; a speaker to receive electrical signals and output audio signals; a microphone to receive audio signals and output electrical signals; a display to output visual information (e.g., text input into communications device 300); and/or a vibrator to cause communications device 300 to vibrate.

Communication interface 340 may include, for example, a transmitter that may convert baseband signals from processing unit 310 to radio frequency (RF) signals and/or a receiver that may convert RF signals to baseband signals. Alternatively, communication interface 340 may include a transceiver to perform functions of both a transmitter and a receiver. Communication interface 340 may connect to antenna assembly 350 for transmission and/or reception of the RF signals.

Antenna assembly 350 may include one or more antennas to transmit and/or receive RF signals over the air. Antenna assembly 350 may, for example, receive RF signals from communication interface 340 and transmit them over the air, and receive RF signals over the air and provide them to communication interface 340. In one implementation, for example, communication interface 340 may communicate with a network and/or devices connected to a network.

As will be described in detail below, communications device 300 may perform certain operations described herein in response to processing unit 310 executing software instructions of an application contained in a computer-readable medium, such as memory 320. The software instructions may be read into memory 320 from another computer-readable medium or from another device via communication interface 340. The software instructions contained in memory 320 may cause processing unit 310 to perform processes that will be described later. Alternatively, hardwired circuitry may be used in place of or in combination with software instructions to implement processes described herein. Thus, implementations described herein are not limited to any specific combination of hardware circuitry and software.

Although FIG. 3 shows exemplary components of communications device 300, in other implementations, communications device 300 may include fewer components, different components, differently arranged components, or additional components than those depicted in FIG. 3. Alternatively, or additionally, one or more components of communications device 300 may perform one or more other tasks described as being performed by one or more other components of communications device 300.

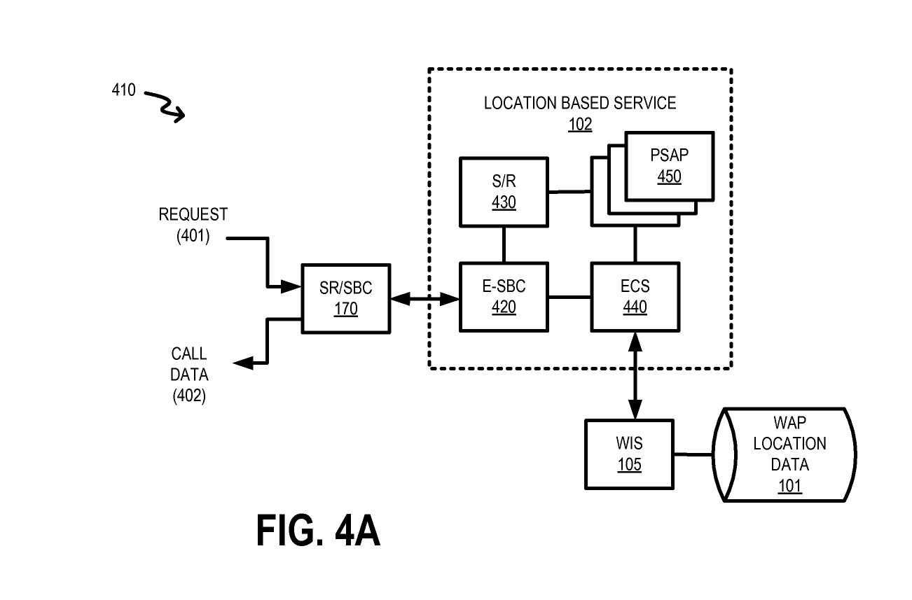

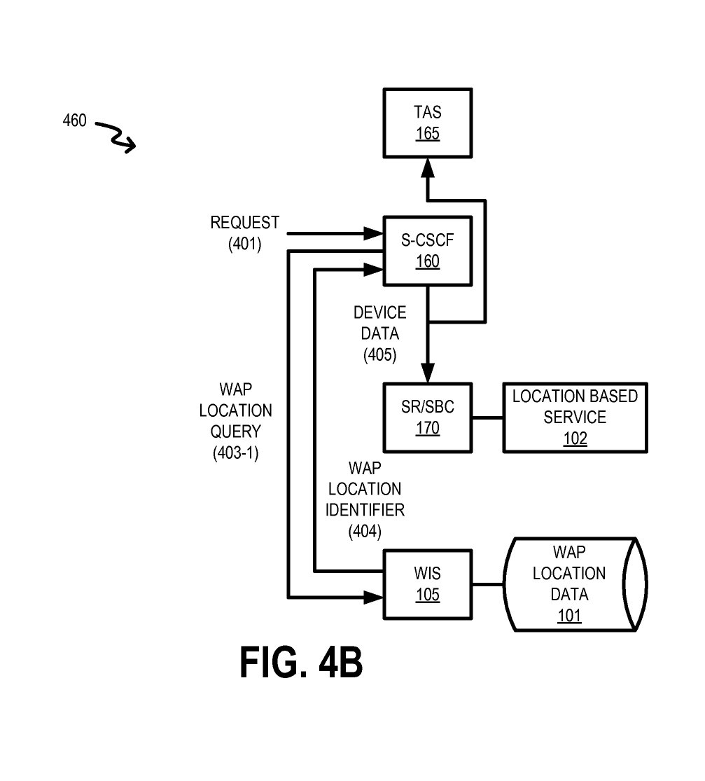

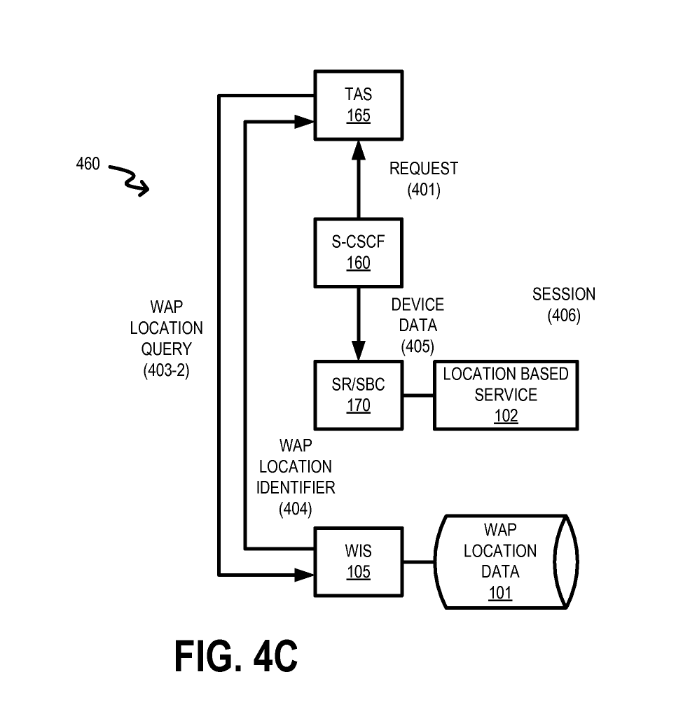

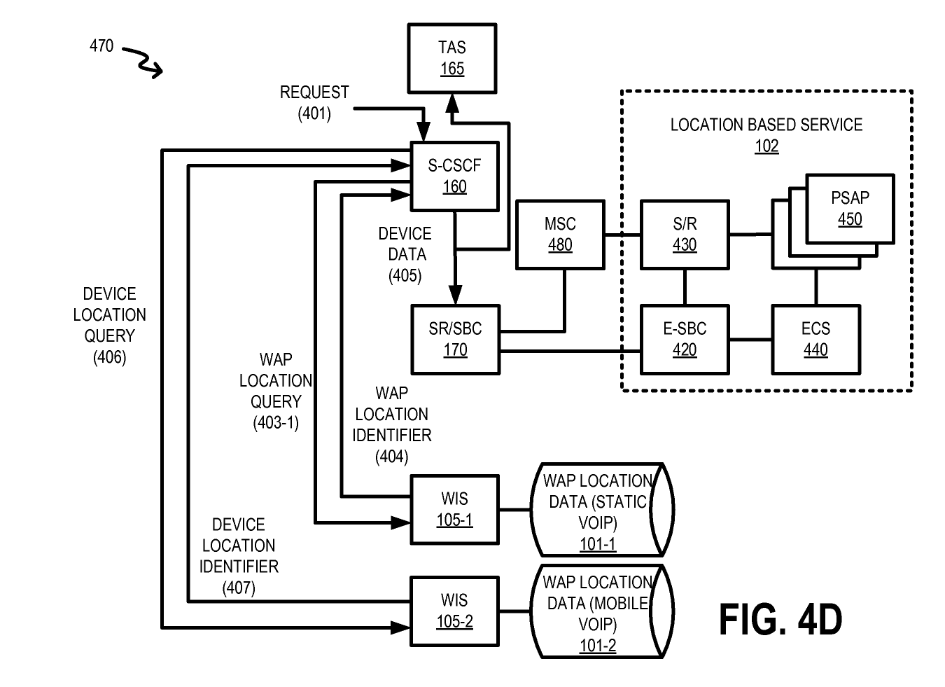

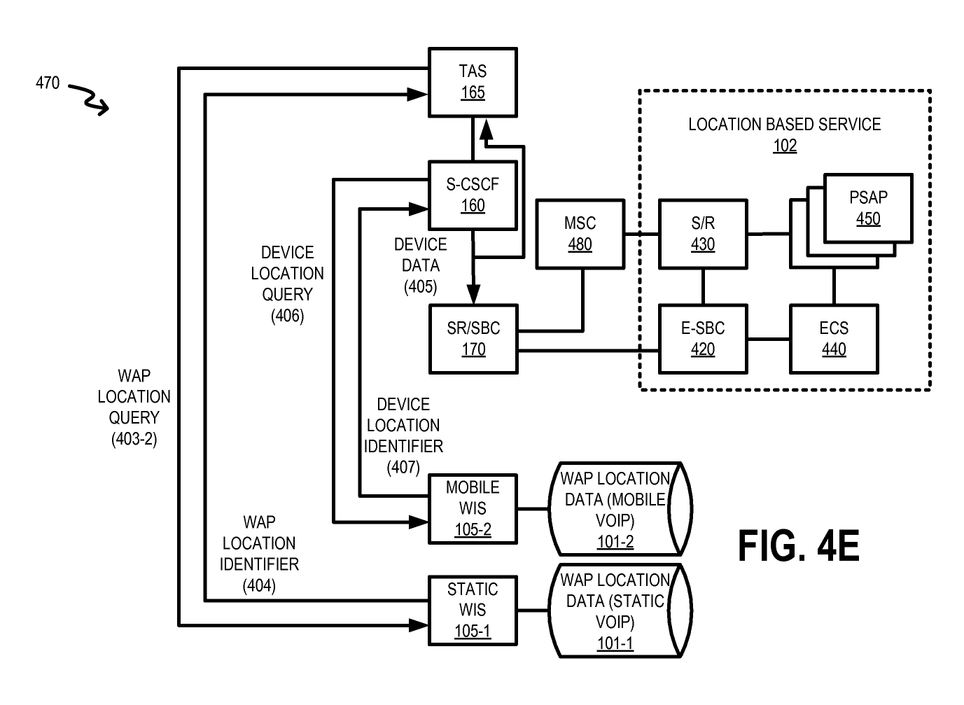

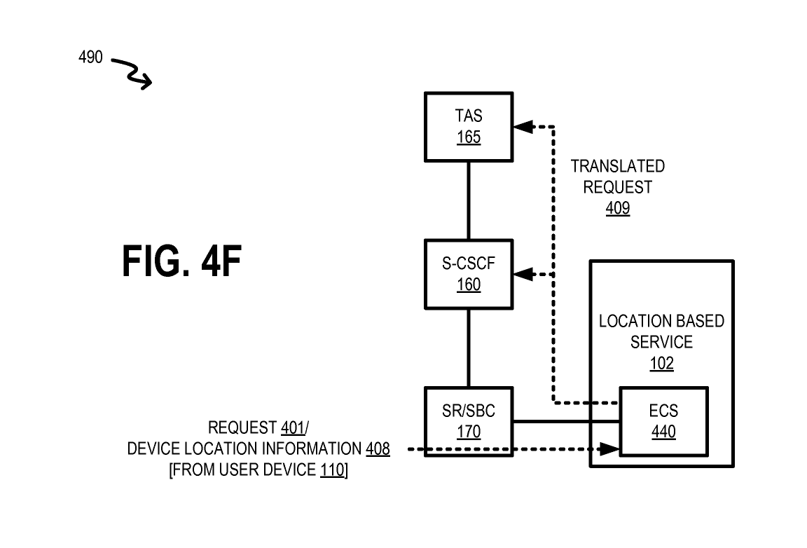

FIG. 4A is a diagram of exemplary operations performed within a first portion 410 of network 100 to connect user device 110 to location-based service 102 via WAP 130. As shown in FIG. 4A, first portion 410 may include location-based service 102, WIS 105, and SR/SBC 170, and these components may operate as described above with respect to network 100. The operations performed in first portion 410 are described with respect to a particular location-based service 102 for handling an emergency call, such as a 911 call, but it should be appreciated that location-based service 102 may be associated with other functions and/or entities. In the particular example shown in FIG. 4A, location-based service 102 may include an emergency SBC (E-SBC) 420, a selective router (SR) 430, an emergency call server (ECS) 440, and a public safety answering point (PSAP) 450 corresponding to a final destination of an emergency call where a “911” operator is located. It should be appreciated, however, that different location-based services 102 may include few, more, or different components.

In first portion 410, a request 401 for location-based service 102, initiated by user device 110 via WAP 130, may be forwarded within network 100 (e.g., via ePDG 140 and PGW 150 or via webGW 145) to SR/SBC 170. Request 401 may be a session initiation protocol (SIP) invitation requesting a connection between user device 110 and an appropriate PSAP 450 (to be identified via WIS 105) and may include data identifying WAP 130. SR/SBC 170 may forward data associated with request 401 to location-based service 102, such as to E-SBC 420.

E-SBC 420 may include one or more devices to control communications to and from location-based services 102. E-SBC 420 may filter request 401 (e.g., determine whether request 401 relates an associated location-based service 102) and may forward a copy of request 401 to other components of location-based services 102. For example, E-SBC 420 may forward a copy of request 401 to SR 430 and/or ECS 440.

SR 430 may include a server device, or other types of computation or communication devices, to route request 401 (e.g., a 911 call) to the appropriate PSAP 450, as determined by ECS 440. SR 430 may include a data transfer device, such as a gateway, a router, a switch, a firewall, a network interface card (NIC), a hub, a bridge, a proxy server, an optical add-drop multiplexer (OADM), or some other type of device that processes and/or transfers data.

PSAP 450 may include a server device, or other types of computation or communication devices, responsible for answering an emergency call from user device 110 (e.g., via WAP 130). PSAP 450 may communicate with emergency personnel (e.g., police, fire, and/or ambulance services, not shown in FIG. 4A) to provide information associated with emergency calls. Various PSAPs 450 may be associated with different locations (e.g., different regions, cities, counties, states, countries), and location-based service 102 may route request 401 to an appropriate particular PSAP 450 responsible for the geographic location associated with user device 110.

In the context of first portion 410, ECS 440 may include a server device, or other types of computation or communication devices, to identify the appropriate PSAP 450 based on the geographic location of WAP 130. For example, ECS 440 may extract an identifier for WAP 130 from request 401 and may use this information to interface with WIS 105 (e.g., via other components of network 100 such as SR/SBC 170) to determine the geographic location for WAP 130. For example, ECS 440 may use the identifier for WAP 130 to query WAP location data 101 to identify the geographic location for WAP 130 and/or identify an associated eNB 125. If ECS 440 determines data identifying an associated eNB, ECS 440 may interface with another component of network 100 (e.g., a location server not shown in FIG. 1 or 4A) to determine a geographic location associated with eNB 125. ECS 440 may further determine a particular PSAP 450 associated with the geographic location. For example, ECS 440 may interface with PSAPs 450 to determine a particular PSAP 450 that would accept request 401 from the identified geographic location. In addition or alternatively, ECS 440 may store data identifying locations associated with PSAPs 450 and may select a particular PSAP 450 to handle request 401 based on the stored data.

E-SBC 420 may generate call data 402 to enable components of network 100 to establish a SIP session or other communications between user device 110 and the selected PSAP 450. For example, E-SBC 420 may cause a first session to be established between E-SBC 420 and the appropriate PSAP 450 via SR 430, and E-SBC 420 may generate call data 402 to enable components of network 100 (e.g., P-CSCF 155, S-CSCF 160, TAS 165 and/or SR/SBC 170) to establish a second session between user device 110 and E-SBC 420 via WAP 130. E-SBC 420 may further bridge the first and second sessions to establish the call between user device 110 and the appropriate PSAP 450.

Although FIG. 4A shows exemplary components of first portion 410, in other implementations, first portion 410 may include fewer components, different components, differently arranged components, or additional components than those depicted in FIG. 4A. Alternatively, or additionally, one or more components of first portion 410 may perform one or more other tasks described as being performed by one or more other components of first portion 410.

FIGS. 4B and 4C are diagrams of exemplary operations performed within a second portion 460 of network 100 to connect user device 110 to location-based service 102 via WAP 130. As shown in FIGS. 4B and 4C, second portion 460 may include location-based service 102, WIS 105, S-CSCF 160, TAS 165, and SR/SBC 170, and these components may generally operate as described above with respect to network 100

In FIG. 4B, in a first exemplary operation within second portion 460, data associated with request 401 for location-based service 102, initiated by user device 110 via WAP 130, may be forwarded within network 100 (e.g., by webGW 145 or P-CSCF 155) to S-CSCF 160. Request 401 may be a session initiation protocol (SIP) invitation requesting a connection between user device 110 and an appropriate PSAP 450 (located inside location-based service 102 as shown in FIG. 4A and to be identified via WIS 105) and may include data (e.g., a MAC address) identifying WAP 130. S-CSCF 160 may extract the data identifying WAP 130 from request 401 and may use the data identifying WAP 130 to determine a location associated with WAP 130. For example, S-CSCF 160 may forward, to WIS 105, a WAP location query 403 (shown in FIGS. 4B and 4D as WAP location query 403-1) based on the data identifying WAP 130, and WIS 105 may use the data to determine the location associated with WAP 130. WIS 105 may forward, to S-CSCF 160, WAP location identifier 404 that includes data (e.g., ECGI, TAC and/or other location identifier) identifying a geographic location of WAP 130.

As further shown in FIG. 4B, S-CSCF 160 may generate device data 405 based on the geographic location of WAP 130. For example, S-CSCF 160 may generate session messages and commands based on the location of WAP 130 in order to request a session with an appropriate location-based service 102 (e.g., a particular location-based service 102 associated with the geographic location of WAP 130). For example, S-CSCF 160 may forward a SIP registration message that includes a multimedia private access network information (mPANI) header that may identify an access technology (e.g. WLAN 120 and WAP 130) used by user device 110 to connect to network 100 and the location of WAP 130 (and closely situated user device 110). For example, S-CSCF 160 may forward device data 405 (e.g., messages that include the mPANI header) to TAS 165 and/or to SR/SBC 170 to establish a SIP session or other connection to particular location-based service 102 associated with the location of WAP 130.

In FIG. 4C, in a second exemplary operation within second portion 460 of network 100, TAS 165 (and not S-CSCF 160) may determine an identifier for WAP 130 (e.g., based on request 401) and may use the identifier of WAP 130 to determine a location associated with WAP 130. For example, TAS 165 may forward, to WIS 105, a WAP location query 403 (shown in FIGS. 4C and 4E as WAP location query 403-2) based on the identifier of WAP 130, and WIS 105 may use the data to determine the location associated with WAP 130. WIS 105 may forward, to TAS 165, WAP location identifier 404 that include data (e.g., ECGI, TAC and/or other location identifier) identifying a geographic location of WAP 130.

As further shown in FIG. 4C, TAS 165 may generate device data 405 based on the geographic location of WAP 130. For example, TAS 165 may generate session messages and commands based on the location of WAP 130 and initiate a session with an appropriate location-based service 102 associated with the geographic location of WAP 130. For example, TAS 165 may forward a SIP registration message that includes the mPANI header identifying the location of WAP 130. For example, TAS 165 may forward device data 405 (e.g., messages that include the mPANI header) to S-CSCF 160. S-CSCF 160 may forward device data 405 to SR/SBC 170 to establish a SIP session or other connection to particular location-based service 102 associated with the location of WAP 130.

Although FIGS. 4B and 4C show exemplary components of second portion 460, in other implementations, second portion 460 may include fewer components, different components, differently arranged components, or additional components than depicted in FIGS. 4B and 4C. Alternatively, or additionally, one or more components of second portion 460 may perform one or more other tasks described as being performed by one or more other components of second portion 460.

In another implementation different from that of FIGS. 4A-4C, network 100 may determine whether user device 110 is placing calls from a single location associated with WAP 130 (e.g., messaging via static VoIP) or whether user device 110 is moving within network 100 and is only temporarily connected through WAP 130 (e.g., user device 110 is located in an moving automobile). For example, S-CSCF 160, TAS 165, or another component of network 100 may determine whether user device 110 is connected to WAP 130 for at least a particular (i.e., a threshold) time period and/or is attempting to connect to eNB 125 (e.g., via WWAN 115).

FIGS. 4D and 4E are diagrams of exemplary operations that may be performed within a third portion 470 of network 100. As shown in FIGS. 4D and 4E, third portion 470 may include location-based service 102, WIS 105 (shown in FIGS. 4D and 4E as static WIS 105-1 and mobile WIS 105-2), S-CSCF 160, TAS 165, and SR/SBC 170. These components may generally operate as described above with respect to network 100. However, static WIS 105-1 may store WAP location data 101-1 associated with static VoIP communications with user device 110, such as publicly available (e.g., a directory of publicly accessible WAPs 130) data that includes an identifier and location data (e.g., ECGI and/or TAC identifiers) associated with WAP 130, and mobile WIS 105-2 may store WAP location data 101-1 associated with mobile VoIP communications with user device 110, such as internal data used in service network, such as an identifier and location data (e.g., ECGI and/or TAC identifiers) associated with an access point corresponding to WAP 130.

In the exemplary operations of third portion 470 shown in FIG. 4D, data associated with request 401 for location-based service 102, initiated by user device 110 via WAP 130, may be forwarded within network 100 (e.g., by webGW 145 or P-CSCF 155) to S-CSCF 160. S-CSCF 160 may extract the data identifying WAP 130 from request 401 and may further determine whether user device 110 is static (e.g., is connected to WAP 130 for more than a threshold time period) or is mobile (e.g., is connected to WAP 130 for less than the threshold time period). In one implementation, when user device 110 is mobile, user device may be sending a request for location-based service 102 from another WAP 130 and eNB 125, and WAP 130 may represent a future access point (e.g., user device 110 appears to be moving toward WAP 130) that is identified based on a pattern in prior access points used by user device 110.

If user device 110 is static, S-CSCF 160 may proceed as described in the discussion of FIG. 4B. For example, S-CSCF 160 may forward, to WIS 105-1, a WAP location query 403-2 that includes a device identifier associated with WAP 130 extracted from request 401. WIS 105-1 may use the device identifier to determine a location associated with WAP 130. WIS 105-1 may forward, to S-CSCF 160, WAP location identifier 404 that includes data (e.g., ECGI, TAC and/or other location identifier) identifying the geographic location of WAP 130.

If user device 110 is mobile, S-CSCF 160 may forward, to WIS 105-2, a device location query 406 that includes a MAC address or other information associated with WAP 130. The MAC address may be extracted from request 401 or determined based on analyzing the movement of user device 110. WIS 105-2 may use the MAC address to determine a location associated with WAP 130. WIS 105-2 may forward, to S-CSCF 160, device location identifier 407 that includes data (e.g., ECGI, TAC and/or other location identifier) associated with the geographic location of WAP 130.

In the exemplary operations of third portion 470 shown in FIG. 4E, TAS 165 may extract the data identifying WAP 130 (e.g., from request 401 received from S-CSCF 160 or another component of network 100) and may further determine whether user device 110 is static or is mobile. If user device 110 is static, TAS 165 may proceed as described in the discussion of FIG. 4C. For example, TAS 165 may forward, to WIS 105-1, a WAP location query 403-2 that includes a device identifier associated with WAP 130 extracted from request 401. WIS 105-1 may use the device identifier to determine a location associated with WAP 130. WIS 105-1 may forward, to TAS 165, WAP location identifier 404 that includes data (e.g., ECGI, TAC and/or other location identifier) identifying the geographic location of WAP 130.

If user device 110 is mobile, TAS 165 may forward a message to cause S-CSCF 160 to forward, to WIS 105-2, a device location query 406 that includes a MAC address or other information associated with WAP 130. The MAC address may be extracted from request 401 or determined based on analyzing the movement of user device 110. WIS 105-2 may use the MAC address to determine a location associated with WAP 130. WIS 105-2 may forward, to S-CSCF 160, device location identifier 407 that includes data (e.g., ECGI, TAC and/or other location identifier) associated with the geographic location of WAP 130.

As further shown in FIG. 4E, S-CSCF 160 may generate device data 405 based on the geographic location of WAP 130 (as received, for example, in WAP location identifier 404 from WIS 105-1 or in device location identifier 407 from WIS 105-2). For example, S-CSCF 160 may generate, as device data 405, session messages and commands based on the location of WAP 130 in order to request a session with an appropriate location-based service 102 (e.g., a particular location-based service 102 associated with the geographic location of WAP 130). For example, S-CSCF 160 may forward a SIP registration message that includes an mPANI header identifying the location of WAP 130. For example, S-CSCF 160 may forward device data 405 (e.g., messages that include the mPANI header) to TAS 165 and/or to SR/SBC 170 to establish a SIP session or other connection to particular location-based service 102 associated with the location of WAP 130. When user device 110 is mobile, SR/SBC 170 may interact with MSC 480 to establish the connection to location-based service 102 so that the connection may be maintained even if user device moves to connect to another access point (e.g., another WAP 130 not shown in FIG. 4E and/or eNB 125). MSC 480 may include a server device or other types of computation or communication devices to set up and release an end-to-end connection, and to handle mobility and hand-over requirements during the call.

Although FIGS. 4D and 4E shows exemplary components of third portion 470, in other implementations, third portion 470 may include fewer components, different components, differently arranged components, or additional components than those depicted in FIGS. 4D and 4E. Alternatively, or additionally, one or more components of third portion 470 may perform one or more other tasks described as being performed by one or more other components of third portion 470.

In another implementation, request 401 for location based service 102 may be handled within network 100 without accessing WIS 105. For example, FIG. 4F shows a diagram of exemplary operations that may be performed within a fourth portion 490 of network 100 to handle request 401 without accessing WIS 105. As shown in FIG. 4F, fourth portion 490 may include location-based service 102, S-CSCF 160, TAS 165, SR/SBC 170, and ECS 440. These components may generally operate as described above with respect to network 100.

As shown in FIG. 4F, user device 110 may determine device location information 408 identifying a geographic location associated with user device 110. For example, user device 110 may determine a geographic location (e.g., longitude and latitude values) based on collected GPS data, based on processing signals received from one or more eNBs 125, etc. User device 110 may determine device location information 408 when connecting to WAP 130 and/or when forwarding request 401 for location-based service 102. In another implementation, user device 110 may receive device location information 408 from another device, such as from eNB 125, WAP 130, and/or from another user device 110.

As further shown in FIG. 4F, user device may forward request 401 toward SR/SBC 170 (e.g., via WebGW 145, PPGW 150, or S-CSCF 160), and SR/SBC 170 may forward request 401 toward location-based service 102. Request 401 may include device location information 408, and ECS 440 in location-based service 102 may determine a modified request 409 that may be used S-CSCF 160 and/or TAS 165 to establish a session between user device 110 and an appropriate location-based service 102. For example, ECS 440 may determine a cell identifier (e.g., ECGI and/or TAC identifiers) associated with the geographic location identified in device location information 408, and ECS 440 may replace, in request 401, location data 408 with the cell identifier to form modified request 409. ECS 440 may forward modified request 409 to S-CSCF 160, TAS 165, or another component of network 100. S-CSCF 160, TAS 165, or the other component of network 100 may use the data included in modified request 409 (e.g., the cell identifier) to establish the session between user device 110 and the appropriate location-based service 102.

Although FIG. 4F shows exemplary components of fourth portion 490, in other implementations, fourth portion 490 may include fewer components, different components, differently arranged components, or additional components than depicted in FIG. 4F. Alternatively, or additionally, one or more components of fourth portion 490 may perform one or more other tasks described as being performed by one or more other components of fourth portion 490.

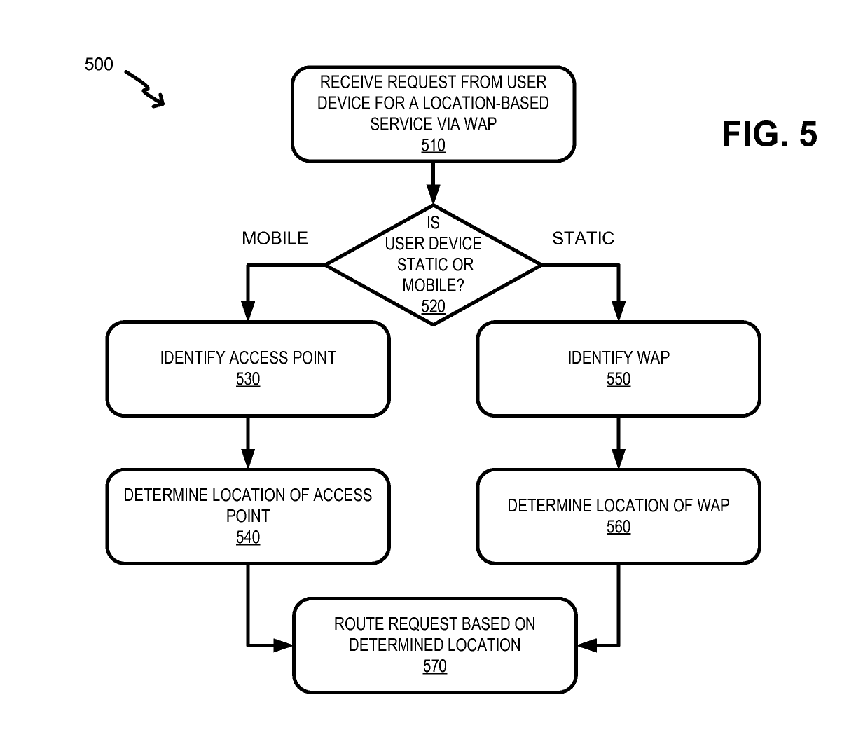

FIG. 5 is a flow chart of an exemplary process 500 for handling a request for a location-based service 102 received via WAP 130. In one implementation, process 500 may be performed by one or more components of network 100, such as WIS 105, P-CSCF 155, S-CSCF 160, TAS 165, and/or SR/SBC 170.

As shown in FIG. 5, process 500 may include receiving, from user device 110, a request for location-based service 102 via WAP 130 (block 510). For example, in implementations described above in connection with FIGS. 4A-4F, user device 110 may forward a SIP INVITE to connect to location-based service 102 (e.g., for a 911 call). When the SIP INVITE is forwarded via WAP 130, WAP 130 may modify the SIP INVITE to include data identifying WAP 130 and may forward the modified SIP INVITE to another component of network 100, such as to S-CSCF 160, TAS 165, and/or SR/SBC 170 via ePDG 140, webGW 145, PGW 150, and/or P-CSCF 155.

As shown in FIG. 5 process 500 may further include determining whether the user device 110 is static or mobile (block 520). For example, S-CSCF 160, may determine how long user device 110 has been connected to WAP 130 and may classify user device 110 as static if user device 110 has been connected to WAP 130 (e.g., via WLAN 120) for a least a threshold amount of time.

As further shown in FIG. 5, if user device 110 is mobile (block 520—“Mobile”), process 500 may further include identifying an access point identifier associated with WAP 130 (block 530) and determining a location associated with the access point identifier (block 540). For example, as described above with respect to third portion 470 in FIGS. 4D and 4E, S-CSCF 160 or TAS 165 may forward device location query 406 that includes a MAC address or other information associated with WAP 130. The MAC address may be extracted from request 401 or determined based on analyzing the movement of user device 110. WIS 105-2 may use the MAC address to determine a location associated with WAP 130. WIS 105-2 may forward, to S-CSCF 160 or TAS 165, device location identifier 407 that includes data (e.g., ECGI, TAC and/or other location identifier) associated with the geographic location of WAP 130.

Alternatively, if user device 110 is static (block 520—“Static”), process 500 may further include identifying WAP 130 (block 550) and determining a location associated with WAP 130 (block 560). For example, as described above with respect to first portion 410 in FIG. 4A, SR/SBC 170 may extract an identifier of WAP 130 (e.g., a device identifier) from request 401 and forward the WAP identifier to location-based service 102. Location-based service 102 uses the WAP identifier to determine an associated location and may initiate an appropriate connection to user device 110.

Alternatively, as described above with respect to second portion 460 in FIGS. 4B and 4C, S-CSCF 160 or TAS 165 may forward WAP location query 403 that includes an identifier for WAP 130. WIS 105 may use the WAP identifier to determine a location associated with WAP 130. WIS 105-2 may forward, to S-CSCF 160 or TAS 165, WAP location identifier 404 that includes data (e.g., ECGI, TAC and/or other location identifier) associated with the geographic location of WAP 130.

Continuing with FIG. 5, process 500 may also include routing the request to an appropriate location-based service 102 based on the geographic location associated with WAP 130 (block 570). For example, S-CSCF 160 or TAS 165 may forward an SIP INVITE message that includes an mPANI header identifying the location of WAP 130 to location-based service 102, and location-based service 102 may handle the SIP INVITE based on the mPANI header. For example, location-based service 102 may extract the location of WAP 130 from the mPANI header and may form an appropriate SIP session between user device 110 and an appropriate component location-based service 102. For example, location-based service 102 may store a record identifying different components (e.g., different PSAP 450) associated with geographic locations and may identify an appropriate component to connect to user device 110 based on the location of WAP 130.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Also, while a series of blocks has been described with respect to process 500 in FIG. 5, the order of the blocks in process 500 may be modified in other implementations to include additional, fewer, and/or different blocks. Furthermore, non-dependent blocks in process 500 may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the implementations. Thus, the operation and behavior of these aspects were described without reference to the specific software code—it being understood that software and control hardware can be designed to implement these aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the implementations includes each dependent claim in combination with every other claim in the claim set.

No element, act, or instruction used in the present application should be construed as critical or essential unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. A method comprising:
receiving, by a processor, a request from a user device to access a location-based service via a wireless access point (WAP);
determining whether the user device is static or mobile, wherein determining whether the user device is static or mobile includes:
determining a length of time that the user device has accessed the WAP;
determining that the user device is mobile when the length of time that the user device has accessed the WAP is less than a threshold amount; and
determining that the user device is static when the length of time that the user device has accessed the WAP satisfies the threshold amount;
identifying, by the processor, a particular WAP identifier associated with the WAP based on the request;
determining, by the processor, a particular geographic location based on the identifier and based on determining whether the user device is static or mobile, wherein a first WAP information service (WIS) stores data associating first geographic locations and WAP identifiers corresponding to a plurality of WAPs that include the WAP, wherein a second WIS stores data associating the WAP identifiers and second geographic locations corresponding to other access points, wherein the first geographic locations differ from the second geographic locations, and wherein determining the particular geographic location includes:
querying, based on determining that the user device is static, the first WIS based on the particular WAP identifier to identify, as the particular geographic location, one of the first geographic locations corresponding to the WAP, and
querying, based on determining that the user device is mobile, the second WIS based on the particular WAP identifier to identify, as the particular geographic location, one of the second geographic locations; and
establishing, by the processor, a communication between the user device and the location-based service based on the particular geographic location.

2. The method of claim 1, wherein the processor is associated with a call session control function (CSCF) or a telephony application servicer (TAS).

3. The method of claim 1, wherein the location-based service is associated with handling an emergency call.

4. The method of claim 1, wherein the processor is associated with an emergency call service (ECS), and wherein establishing the communication includes:
selecting a particular public safety answering point (PSAP) from a plurality of PSAPs based on the particular geographic location, and
establishing the communication between the user device and the particular PSAP.

5. The method of claim 1, wherein establishing the communication includes forwarding a session initiation protocol (SIP) message that includes header data identifying the particular geographic location.

6. (canceled)

7. The method of claim 1, wherein querying the first WIS based on the particular WAP identifier includes identifying at least one of a tracking area code (TAC) associated with the WAP or an enhanced global cell identity (ECGI) associated with the WAP.

8. A device comprising:
a memory configured to store instructions; and
a processor configured to execute one or more of the instructions to:
receive a request from a user device to access a location-based service via a wireless access point (WAP);
determine whether the user device is static or mobile, wherein the processor, when determining whether the user device is static or mobile, is further configured to:
determine a length of time that the user device has accessed the WAP;
determine that the user device is mobile when the length of time that the user device has accessed the WAP is less than a threshold amount; and
determine that the user device is static when the length of time that the user device has accessed the WAP satisfies the threshold amount;
identify a particular WAP identifier associated with the WAP based on the request;
determine a particular geographic location based on the identifier and based on determining whether the user device is static or mobile, wherein a first WAP information service (WIS) stores data associating first geographic locations and WAP identifiers corresponding to a plurality of WAPs that include the WAP, wherein a second WIS stores data associating the WAP identifiers and second geographic locations corresponding to other access points, wherein the first geographic locations differ from the second geographic locations, and wherein the processor, when determining the particular geographic location, is further configured to:
query, when the user device is static, the first WIS based on the particular WAP identifier to identify, as the particular geographic location, one of the first geographic locations corresponding to the WAP, and
query, when the user device is mobile, the second WIS based on the particular WAP identifier to identify, as the particular geographic location, one of the second geographic locations; and
establish a communication between the user device and the location-based service based on the particular geographic location.

9. The device of claim 8, wherein device is associated with a call session control function (CSCF) or a telephony application servicer (TAS).

10. The device of claim 8, wherein the location-based service is associated with handling an emergency call.

11. The device of claim 8, wherein the device is associated with an emergency call service (ECS), and wherein the processor, when establishing the communication, is further configured to execute one or more of the instructions to:
select a particular public safety answering point (PSAP) from a plurality of PSAPs based on the particular geographic location, and
establish the communication between the user device and the particular PSAP.

12. The device of claim 8, wherein the processor, when establishing the communication, is further configured to execute one or more of the instructions to:
forward a session initiation protocol (SIP) message that includes header data identifying the particular geographic location.

13. (canceled)

14. The device of claim 8, wherein the processor, when querying the first WIS based on the particular WAP identifier, is further configured to execute one or more of the instructions to:
identify at least one of a tracking area code (TAC) associated with the WAP or an enhanced global cell identity (ECGI) associated with the WAP.

15. A non-transitory computer readable medium to store instructions, the instructions comprising:
one or more instructions that, when executed by a processor associated with a device, cause the processor to:
receive a request from a user device to access a location-based service via a wireless access point (WAP);
determine whether the user device is static or mobile, wherein the one or more instructions further cause the processor, when determining whether the user device is static or mobile, to:
determine a length of time that the user device has accessed the WAP;
determine that the user device is mobile when the length of time that the user device has accessed the WAP is less than a threshold amount; and
determine that the user device is static when the length of time that the user device has accessed the WAP satisfies the threshold amount;
identify a particular WAP identifier associated with the WAP based on the request;
determine a particular geographic location based on the identifier and based on determining whether the user device is static or mobile, wherein a first WAP information service (WIS) stores data associating first geographic locations and WAP identifiers corresponding to a plurality of WAPs that include the WAP, wherein a second WIS stores data associating the WAP identifiers and second geographic locations corresponding to other access points, wherein the first geographic locations differ from the second geographic locations, and wherein the one or more instructions further cause the processor, when determining the particular geographic location, to:
query, when the user device is static, the first WIS based on the particular WAP identifier to identify, as the particular geographic location, one of the first geographic locations corresponding to the WAP, and
query, when the user device is mobile, the second WIS based on the particular WAP identifier to identify, as the particular geographic location, one of the second geographic locations; and
establish a communication between the user device and the location-based service based on the particular geographic location.

16. The non-transitory computer readable medium of claim 15, wherein device is associated with a call session control function (CSCF) or a telephony application servicer (TAS).

17. The non-transitory computer readable medium of claim 15, wherein the location-based service is associated with handling an emergency call.

18. The non-transitory computer readable medium of claim 15, wherein the device is associated with an emergency call service (ECS), and wherein the one or more instructions further cause the processor, when establishing the communication, to:
select a particular public safety answering point (PSAP) from a plurality of PSAPs based on the particular geographic location, and
establish the communication between the user device and the particular PSAP.

19. The non-transitory computer readable medium of claim 15, wherein the one or more instructions further cause the processor, when establishing the communication, to:
forward a session initiation protocol (SIP) message that includes header data identifying the particular geographic location.

20. (canceled)

21. The method of claim 1, wherein the WAP is a first WAP, and wherein establishing the communication between the user device and the location-based service based on the particular geographic location includes:
when the user device is mobile, establishing, via the first WAP, a first connection between the user device and the location-based service;
detecting, during communications via the first connection, that the user device connects to a second WAP;
establishing, via the second WAP and based on detecting that the user device connects to the second WAP, a second connection between the user device and the location-based service via the second WAP; and
releasing the first connection based on establishing the second connection, wherein releasing the first connection causes the user device to be handed over to the second WAP.

22. The device of claim 8, wherein the WAP is a first WAP, and wherein the processor, when establishing the communication between the user device and the location-based service based on the particular geographic location, is further configured to:
establish, via the first WAP and when the user device is mobile, a first connection between the user device and the location-based service;
detect, during communications via the first connection, that the user device connects to a second WAP;
establish, via the second WAP and based on detecting that the user device connects to the second WAP, a second connection between the user device and the location-based service via the second WAP; and
release the first connection based on establishing the second connection, wherein releasing the first connection causes the user device to be handed over to the second WAP.

23. The non-transitory computer readable medium of claim 15, wherein the WAP is a first WAP, and wherein the one or more instructions further cause the processor, when establishing the communication between the user device and the location-based service based on the particular geographic location, to:
establish, via the first WAP and when the user device is mobile, a first connection between the user device and the location-based service;
detect, during communications via the first connection, that the user device connects to a second WAP;
establish, via the second WAP and based on detecting that the user device connects to the second WAP, a second connection between the user device and the location-based service via the second WAP; and
release the first connection based on establishing the second connection, wherein releasing the first connection causes the user device to be handed over to the second WAP.
